(19) United States
(12) Patent Application Publication
(10) Pub. No.: US 2015/0144817 A1
(43) Pub. Date: May 28, 2015

(54) SHUTOFF VALVE

(71) Applicant: LacTec GmbH, Rodgau (DE)

(72) Inventors: STEFAN POHL, Rodgau (DE); Stefan Käufer, Egelsbach (DE); Volker Weiss, Frankfurt (DE)

(21) Appl. No.: 14/550,087

(22) Filed: Nov. 21, 2014

(30) Foreign Application Priority Data
Nov. 22, 2013 (EP) 131 941 21.3

(51) Int. Cl. F16K 31/122; B05B 15/02; F16K 1/38

(52) U.S. Cl. CPC F16K 31/122; F16K 1/38; B05B 15/02
USPC 251/63.5

(57) ABSTRACT

A shutoff valve, in particular for shutting off a paint conducting channel in a painting plant, includes a shutoff body, a pressure-operated stroke piston movable in an opening direction, thereby moving the shutoff body from a closed position into an open position; and a piston stop limiting a stroke travel of the stroke piston in the opening direction, and being adjustable to assume different working positions along the opening direction.

### CROSS-REFERENCES TO RELATED APPLICATIONS

This application claims the benefit of prior filed European Patent application No, EP 131 941 21.3 filed Nov. 22, 2013, pursuant to 35 U.S.C. 119(e), the disclosure of which is incorporated herein by reference.

### BACKGROUND OF THE INVENTION

The invention relates to a shutoff valve, in particular for shutting off a paint-conducting channel of a painting plant.

The following discussion of related art is provided to assist the reader in understanding the advantages of the invention, and is not to be construed as an admission that this related art is prior art to this invention.

In modern coating plants, in particular in painting plants, the painting of objects, for example motor vehicle bodies, is predominantly or even exclusively performed automatically by machines. In such processes paint is applied onto the object to be painted with the aid of automatically controlled application devices. In many cases the same application device is used to apply paint of not only one particular color. Rather it is often required or desired to sequentially apply paints of different colors with the application device.

For this purpose color changers or color changing devices are usually provided, which have a central color channel connected with the application device, and multiple color supply lines via which the different paints of different colors can be supplied to the color channel. The supply of the color by these color supply lines is usually controlled by valves which are usually pneumatically controllable. For this purpose valve bores are provided in a valve block of the color changer, into which these valves can be inserted. When actuated, i.e., when needed, the valves release the passage of the respective color supply line to the central color channel. In this way the respective color channel can be opened through which the currently required paint is supplied. Many applications may require supplying paints with more than 10 or 20 different colors. Such a color changing device or changing unit for coating material is for example known from EP 1 859 872 A2.

Prior to each color change the central paint conducting line, which leads from the color changer to the respective application device, for example an atomizer, and enters into the application device, has to be cleaned of contaminations of the previously used paint. This ensures that paints of different colors do not mix immediately after the color change when conducted to a receiving site, for example an application device or an atomizer, which would otherwise significantly impair the quality of the painting. The paint that is removed during such a cleaning process from the line that conducts the paint, is so to speak waste and thus constitutes paint that is no longer available for the painting. The longer and larger the paint conducting line, the greater the amounts of paint that have to be discharged prior to each color change. In particular in the case of large plants this causes significant costs so that there is a general need to minimize these amounts of lost paint as much as possible.

During such a cleaning process the residual paint amount that may still reside in the paint conducting line is usually first pushed out of the respective paint conducting line by means of an appropriate purging medium. A purging medium can for example be. air or preferably also a cleaning or rinsing fluid via which residual paint, which may still be present in the line, is dislodged and carried out. Subsequently the rinsing liquid is pushed out of the paint conducting line, for example by means of pressurized air or the like, so that the line can now be filled with the new paint. In this refilling of the paint conducting line with paint the paint is pushed into the line, whereby the medium, which is still present in the line, for example air or the cleaning or rinsing liquid, is displaced by the paint. As soon as the paint conducting line is filled with the new paint along its entire length from the color changer to the receiving site, in particular the application device or an atomizer, the system is available again for application of the paint.

In order to enable during such a cleaning and rinsing procedure the required change of medium in the paint conducting line particularly reliably and in a relatively short time, the paint conducting line is usually connected at its end in a region close to the entry site into the application device or the atomizer to branching or stub line which can be shut off with a shutoff valve (also referred to as dump-valve), via which the used rinsing medium can be discharged. This shutoff valve is usually operated so that the rinsing medium used in the paint conducting line can be discharged via this valve; the shutoff valve thus opens during the rinsing and cleaning process. Subsequently, when new paint is pushed into the paint conducting line, the air column, which is usually present in the paint conducting line during this phase, is discharged via the shutoff valve. As soon as the paint conducting line is fully filled with the new paint the new paint, instead of air, now exits from the stub line, which can be shut off with the shutoff valve. As soon as this event is detected, the shutoff valve, and via the shutoff valve the stub line, is closed. The rinsing and color changing process is then complete and the new paint can now be outputted via the receiving site of the application device, which is connected to the paint conducting line.

It would therefore be desirable and advantageous to provide an improved to obviate prior art shortcomings and to provide a shutoff valve of the above-mentioned type, which is particularly suited for use in such a painting plant, wherein in particular the paint losses occurring during the color change are further minimized.

### SUMMARY OF THE INVENTION

According to one aspect of the present invention, a shutoff valve, in particular for shutting off a paint conducting channel in a painting plant, includes a shutoff body, a pressure-operated stroke piston movable in an opening direction, thereby moving the shutoff body from a closed position into an open position; and a piston stop limiting a stroke travel of the stroke piston in the opening direction, and being adjustable to assume different working positions along the opening direction

The invention is based on the idea that for minimizing the unavoidable paint losses during the color change all paint loss amounts are to be kept consistently low. This present approach recognizes and takes into account that the amount of lost paint also includes the paint amount that arrives at the shutoff valve during refilling of the paint conducting line and exits through the shutoff valve before the shutoff valve is closed. The relevance of this is that due to reasons of temporal efficiency and high process speeds the shutoff or dump valve is usually configured to have a relatively large channel cross section in order to enable a high throughput rate of the rinsing medium during the cleaning of the paint conducting line. This leads to the fact that when refilling the paint conducting line the air initially present in this line also exits at relatively high channel cross sections from the shutoff valve until the refilled paint column arrives at the shutoff valve and exits surge-like from the shutoff valve. The shutoff valve should therefore be configured to minimize this unavoidable paint surge.

In order to enable the aforementioned goal, the shutoff valve should be configured to be changeable between at least two operating modes. As a first operating mode, which is in particular provided for the actual rinsing process and the associated exit of the rinsing medium associated therewith, the shutoff valve should be operable with a relatively large channel cross section. In a second operating mode on the other hand, which is in particular provided for the phase of initiating pushing the paint in which the air column present in the line is pushed out through the shutoff valve, the shutoff valve should be operated with a relatively small free channel cross section. As a result of this relatively small channel cross section the air column can escape relatively unimpeded; however, as soon as the relatively viscose paint column arrives at the valve, the flow through the relatively small channel cross section is significantly impeded and only a small paint amount exits from the valve before it can be completely closed.

For providing the at least two operating modes the shutoff valve includes a changeable or adjustable stop for the shutoff body. This can be achieved in a particularly simple manner in that the stroke piston, which is provided for the positioning of the shutoff body, is limited in its stroke travel by an adjustable piston stop.

According to another advantageous feature of the invention, the piston stop is adjustable along the opening direction within a range from at least 0 mm to at most 10 mm, particularly preferably of at most 3 mm.

The piston stop can be controlled in an appropriate manner for example manually or electromagnetically. A particularly simple and with this preferred construction can be achieved however in that the piston stop—as well as the actual stroke piston—are pneumatically controllable, wherein particularly preferably the same control pressure may be provided for both. To this end, in a further advantageous embodiment the piston stop is supported and guided by a working piston, which runs in a cylinder.

A particularly simple and compact construction can be achieved, in that the working piston in a further advantageous embodiment is guided concentrically relative to the stroke piston. Particularly preferably the working piston has a greater diameter than the stroke piston. This configuration enables a particularly simple construction because it enables an impingement of both pistons with the same working pressure so that the corresponding pressure-carrying system can be kept relatively simple. This is so because in spite of a same working pressure for both pistons this construction makes it possible to keep the force acting on the working piston greater than the force acting on the stroke piston, so that the actuated or pressure impinged stroke piston cannot displace the simultaneously actuated or pressure impinged working piston.

Advantageously the working piston is itself also assigned a stroke limiter for limiting its stroke travel. This ensures that when actuating the working piston—assuming the presence of sufficient control pressure for overcoming the spring restoring force—a defined operating position, which is independent of the control pressure, is assumed so that correspondingly also the channel cross sections assume defined values. In a particularly advantageous embodiment the stroke limiter is itself adjustable regarding its operating position. As a result the channel cross sections can be appropriately adjusted according to the individual system requirements.

This can be achieved in a particularly simple manner in that particularly preferably the stroke limiter, which is assigned to the working piston, can be positioned via a knurled screw. The knurled screw is particularly preferably provided with means for rotational fixation, advantageously with a number of threaded pins, thereby after appropriate positioning and fixing of the components, enabling a reliable system operation with constant operating parameters.

Advantageously the stroke limiter is arranged inside the working piston thus resulting in a particularly compact construction.

In an advantageous embodiment the shutoff body is configured as a valve needle. In a further advantageous embodiment, the valve needle has a replaceable and/or screwable needle tip thus rendering maintenance of the shutoff valve particularly easy.

The configuration of the shutoff body as valve needle can be achieved in a particularly simple manner in that the lift of the preferably conically configured valve needle from its needle seat determines the free channel cross section. This makes it possible to effect a change of the free channel cross section by an appropriate change of the stroke travel.

With regard to the painting plant the mentioned object is solved in that a number of paint conducting lines which each lead into a receiving site or application device can be shut off and/or branching and stub lines, which branch off from the paint conducting lines.

The advantages achieved with the invention are in particular that the preferably pneumatically controlled settable piston stop of the stroke piston, which carries and guides the shutoff member, enables in a particularly simple manner, i.e., through appropriate positioning of the piston stop, a switching between two or more operating modes for the shutoff valve. With this by appropriately controlling the piston stop the stroke of the stroke piston can be adjusted in a first operating mode so that a comparably great free channel cross section is established in the region of the opened valve. On the other hand, by appropriately limiting the piston stroke in a second operating mode it can be ensured that when the valve is open only a relatively small channel cross section is present. With this a relatively great free channel cross section can be set on one hand in the rinsing operation, so that the rinsing medium can flow through the paint conducting line with a relatively high flow rate, which benefits a high process speed. On the other hand it can also be ensured that when ventilating the paint conducting line during the pushing in a relatively small free channel cross section can be set which enables an unproblematic escape of the air present in the paint conducting line but at the same time also prevents excessive surge losses when the relatively viscous paint arrives at the valve exit.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a section of a painting plant with a paint conducting line, which leads from a color changer to an application device.

FIG. 2 shows a shutoff valve for the painting plant according to FIG. 1, and

FIGS. 3a-3c respectively show a section of the shutoff valve according to FIG. 2 in different operating states.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

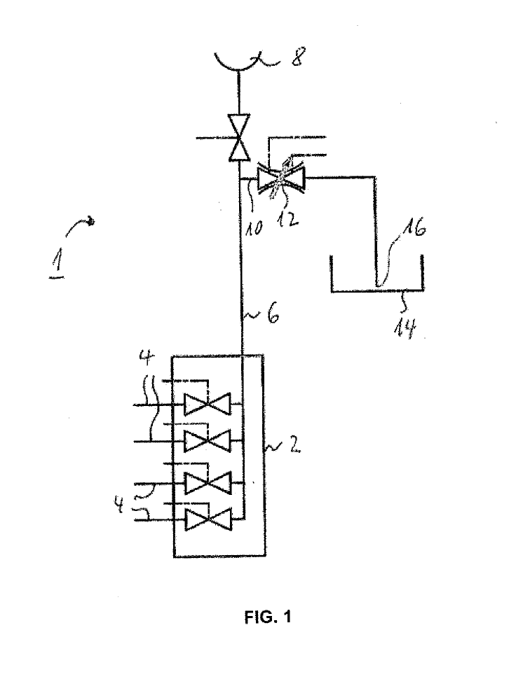

The painting plant 1, of which only a section is shown in FIG. 1, is provided for outputting also relatively small amounts of paint of different paint types and is thus particular suited for coating motor vehicle parts such as vehicle bodies or the like also in small volume production. For this the painting plant includes a color changer 2 which by using structural parts and components known per se, is connected to a number of paint supply lines 4 within the framework of a paint supply system. At the side of the outlet the color changer 2 is connected to a paint conducting line 6 which forms a central color channel for paint side connection of the color changer 2 with the end side arranged application device 8, in particular an atomizer. In the region of the entry site of the paint conducting line 6 into the application device 8 a branch line or stub line 10 branches off from the paint conducting line 6, which can be shut off with a shutoff valve 12 and enters on the outlet side into a discharge container 14. The branch line or stub line 10 serves for discharging rinsing medium or the like if needed in connection with the cleaning of the paint conducting line 6 during a color change. The shut off vale 12, which is also referred to as “dump-valve”, releases the branch or stich line 10 during this process, when discharge of the medium for example by circumventing the application device 6 is desired, for example for rinsing or discharge purposes.

In such a rinsing process the paint conducting line 6 is first impinged with the rinsing medium supplied via one of the lines 4, which rinsing medium is discharged out of the paint conducting line 6 again via the branching or stich line 10. During the rinsing process the shutoff valve 12 is thus opened. After exit of the rinsing medium, which for example can be pushed out of the paint conducting line 6 by means of pressurized air supplied via one of the lines 4, the paint conducting line 6 is filled with the new paint. During this phase of the so-called initial pushing in, the paint column of the new paint is pushed into the paint conducting line 6, wherein the air column, which is still present in the paint conducting line 6, is pushed out through the shutoff valve 12. In this phase the shutoff valve 12 is also open. As soon as the residual air, which is still present in the line 6, is completely pushed out, the paint column arrives in the end region of the paint conducting line 6 and with this in the region of the shutoff valve 12. After the residual air is completely pushed out, the newly filled in paint begins to exit out of the shutoff valve 12 in the direction of the exit opening 16 of the stub line 10. As soon as this is the case, the shutoff valve 12 is closed and the paint system 1 is operable for outputting the newly filled-in paint.

The shutoff valve 12 is specifically configured to minimize the paint losses occurring during such a color change in form of a paint surge, which arrives at the shutoff valve 12 in the case of the paint column in a targeted manner. For this the shutoff valve 12 is configured for at least two different operating modes, wherein in a first operating mode provided for the rinsing phase at open shutoff valve 12 a relatively large free channel cross section is released. In contrast in a second operating mode provided for the ventilation phase of the paint conducting line 6 at open shutoff valve 12 only a relatively small channel cross section is released which enables an unimpeded escape of the air out of the paint conducting line 6 which however limits the surge like exit of the arriving paint as far as possible.

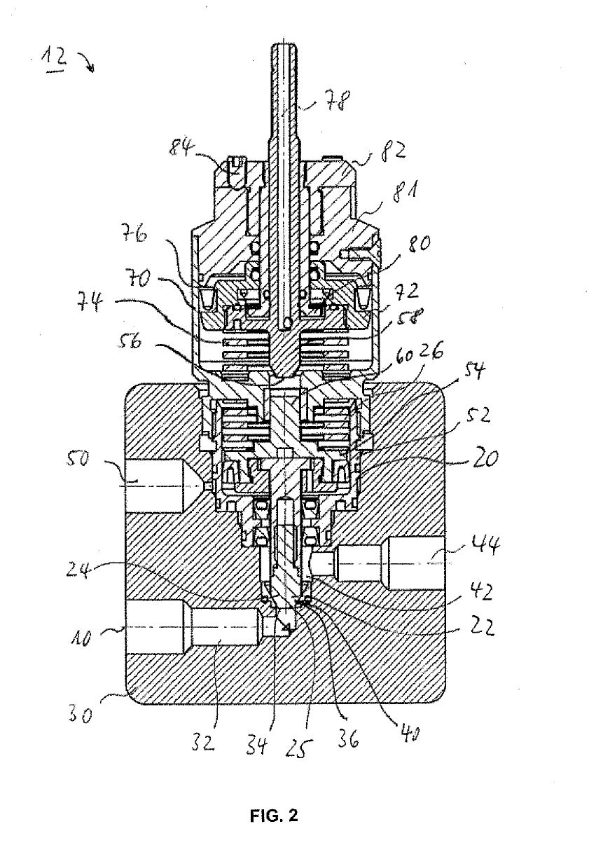

As can be seen from the longitudinal sectional view of FIG. 2, the shutoff valve 12 is configured as pneumatically operable valve. For this the shutoff valve 12 includes an inner housing 20 in which a valve needle 24 configured as shutoff body 22 is supported so as to be displaceable along its axis. The valve needle 24 is provided with a replaceable needle tip 25 and in closed position is impinged by a pressure spring 26.

The shutoff valve 12 can be configured as independent separate component. In the exemplary embodiment the shutoff valve 12 is however screwed into a valve block 30 in the manner of an integrated construction. In this valve block an inlet channel 32 is guided which is connected on the inlet side with the branching or stub line 10. The inlet channel 32 enters into a circular outlet opening 34, which forms a valve seat with its conical flank 36 for the valve needle 24 or its needle tip 25. Resting in the closed position of the shutoff valve 12 against this valve seat, which is formed by the flank 36, is the also conically configured sealing surface 40 of the valve needle 24. Via the outlet opening 34 the inlet channel 32 is connected with the interior space 42 of the shutoff valve 12, which in turn is connected with the outlet channel 44.

The shutoff valve 12 is pneumatically operated by pressurized air. The pressurized air is supplied to a control housing 52, which is assigned to the shutoff valve 12, via a pressurized air channel 50. The control housing 52 forms a pressure cylinder in which a stroke piston 54 is supported and guided. The stroke piston 54 carries the valve needle 24 so that a change of the position of the stroke piston 54 inside the control housing 52 leads to a corresponding change of the position of the valve needle 24. The pressurized air supplied via the pressurized air channel 50 moves the stroke piston 54 against the spring force exerted by the pressure spring 26 so that the valve at sufficient pressurization of the stroke piston 54 opens out of is closed position.

The stroke travel of the stroke piston 54 is limited viewed in its opening direction by a piston stop 56. In the exemplary embodiment the piston stop 56 is formed by the front surface of the stop pin 58 against which a corresponding stop pin 60 arranged on the stroke piston 54 abuts.

In order to enable the intended change between different operating modes of the shutoff valve 12, the piston stop 56 provided for limiting the stroke travel of the stroke piston 54 is adjustable. In the exemplary embodiment a pneumatic control of the piston stop 56 is provided. For this the stop pin, which forms the piston stop 56, is supported and guided by a working piston 72, which runs in and is guided in a cylinder 70. The working piston 72 which is guided in a housing with its center axis concentric to the center axis of the stroke piston 54, which housing is formed by the inner housing 20 and the cylinder 70 and has a greater diameter compared to the stroke piston 54, is herby also impinged by a pressure spring 74 in a resting position. The operating pressure in the pressure chamber 76 acts against the spring force of the pressure spring 74 so that through appropriate pressurization of the pressure chamber 76 the working piston 72 and with this the piston stop 56 can be positioned depending on the operating condition. The pressurization of the pressure chamber 76 can occur in the framework of a pneumatic control via the pneumatic control impulse introduced by the pressure channel 78, which is guided along the center axis of the hub and working piston 54, 72. The working piston 72 is thus controlled “from above” via the pressure channel 78, which is configured in the manner of a hollow needle, wherein the control pressure inside the cylinder 70 is conducted onto the “upper” side of the working piston 72, which faces away from the stop pin 58.

In the shown embodiment the pneumatic actuation of the working piston 72 is thus guided through the cylinder cover 81 into the pressure chamber 76; as an alternative the pneumatic control of the working piston 72 can however also be guided onto its side which faces away from the piston stop 56.

In order to enable a mechanically defined adjustment of the opening pathways of the system, a stroke limiter 80, which can be adjusted in its position, is also provided for the working piston 72. The stroke limiter 80 is supported by a knurled screw 82, which is arranged in the cylinder 70 and is in engagement with an inner thread of the cylinder cover 81. Due to the threaded engagement in the cylinder cover 81, a rotation of the knurled screw 82 is converted into a longitudinal displacement and with this a longitudinal displacement of the stroke limiter 80 so that a manual positioning of the stroke limiter 80 is possible. For rotative fixation of a properly positioned knurled screw 82 one or more threaded pins 84 are provided in its border region.

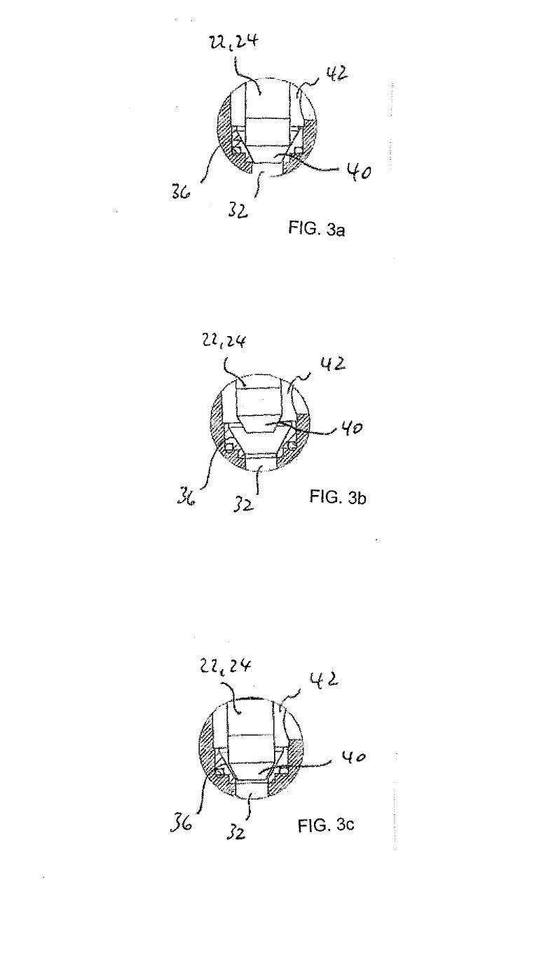

The general functional principle of the shutoff valve 12 is explained in more detail in the enlarged section of the region of the valve seat of the valve needle 24 in FIGS. 3a-c. FIG. 3a shows the closed state of the shutoff valve 12 in which the conically configured sealing surface 40 of the valve needle 24 completely rests against the also conically configured flank 36 of the outlet opening 34. On the other hand FIG. 3b shows the shutoff valve 12 in the opened state in a first operating mode, which is provided for the phase of the actual rinsing with desired high flow-through of the medium through the shutoff valve 12. In this first operating mode the working piston 72 is held in its resting state by the spring force of the pressure spring 74 and with this the stop pin 58 in its resting position and with this with a relatively large distance to the stop pin 60. With this the piston stop 56 is also positioned away from the valve needle 24 thereby permitting a relatively large stroke travel for the stroke piston 54. When the shutoff valve 12 is opened in this operating state, the valve needle 24 can thus retreat comparatively far out of its valve seat so that in the region of the outlet opening 34 a relatively large channel cross section is released.

On the other hand, FIG. 3c shows the shutoff valve 12 in the opened state for a second operating state in which only a relatively small channel cross section is to be released. This second operating state is provided for the ventilation phase of the paint conducting line 6 during initial pushing in so that the residual air present in the paint conducting line 6 can escape relatively easily, whereas only relatively small amounts of the arriving paint can pass the shutoff valve 12. To this end, in this second operating state the pressure chamber 76 of the working piston 72 is impinged with a control pressure so that the working piston 72 is moved in the direction of the stop pin 60. During this the stop pin 568 is caused to assume a position, which is essentially defined by the positioning of the knurled screw 82. As a consequence in this operating state the piston stop 56 is located relatively close to the valve seat so that the stroke travel of the stroke piston 54 is limited to a relatively small range. As a result the valve needle 24 can only move out of its valve seat to a relatively small degree, so that the released channel cross section remains relatively small.

The degree of the displacement of the working piston 72 when actuated and with this the change of the stroke travel of the stroke piston 54 during switching between these two operating states can be fixed and preset by the corresponding positioning of the stroke limiter 80 by means of the knurled screw 82. With this the corresponding free channel cross sections and with this the flow-through amounts in the two operating modes can be pre-adjusted as needed corresponding to the individual requirements of the system.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A shutoff valve, a comprising:
a shutoff body;
a pressure-operated stroke piston movable in an opening direction, thereby moving the shutoff body from a closed position into an open position; and
a piston stop limiting a stroke travel of the stroke piston in the opening direction, and being adjustable to assume different working positions along the opening direction.

2. The shutoff valve of claim 1, wherein the shutoff valve is constructed for shutting off a paint conducting channel in a painting plant.

3. The shutoff valve of claim 1, wherein the piston stop is adjustable along the opening direction within a range from at least 0 mm to at most 10 mm.

4. The shutoff valve of claim 3, wherein the piston stop is adjustable along the opening direction within a range from at least 0 mm to at most 3 mm.

5. The shutoff valve of claim 1, wherein the piston stop is pneumatically controllable.

6. The shutoff valve of claim 5, further comprising a working piston which runs in a cylinder, wherein piston stop is supported and guided by the working piston.

7. The shutoff valve of claim 6, wherein the working piston is guided concentrically relative to the stroke piston.

8. The shutoff valve of claim 6, further comprising a stroke limiter assigned to the working piston for limiting a stroke travel of the working piston, wherein a working position of the stroke limiter is adjustable.

9. The shutoff valve of claim 8, wherein the stroke limiter is arranged inside the working piston.

10. The shutoff valve of claim 8, further comprising a knurled screw, wherein the stroke limiter is positionable via the knurled screw.

11. The shutoff valve of claim 10, wherein the knurled screw is provided with a threaded pins for rotative fixation of the knurled screw.

12. The shutoff valve of claim 6, wherein the working piston has a greater diameter than the stroke piston.

13. The shutoff valve of claim 6, wherein the stroke piston and the working piston are guided concentrically in a common housing.

14. The shutoff valve of claim 1, wherein the shutoff body is configured as a valve needle.

15. The shutoff valve of claim 14, wherein the valve needle has an exchangeable needle tip.
